(19) United States
(12) Patent Application Publication
(10) Pub. No.: US 2024/0208303 A1
(43) Pub. Date: Jun. 27, 2024

(54) Heat-Pipe based Ambient Heat Exchange Method for Producing Water from the Air

(71) Applicants: Brian SHENG, Orlando, FL (US); Xing Kun SHENG, Orlando, FL (US)

(72) Inventors: Brian SHENG, Orlando, FL (US); Xing Kun SHENG, Orlando, FL (US)

(21) Appl. No.: 18/538,214

(22) Filed: Dec. 13, 2023

Related U.S. Application Data
(60) Provisional application No. 63/435,356, filed on Dec. 27, 2022.

(51) Int. Cl. B60H 1/32

(52) U.S. Cl. CPC B60H 1/3227; B60H 1/32281

(57) ABSTRACT

A water generation system according to some aspects of the present invention includes at least one condensation chamber having at least one internal volume, and at least one heat pipe thermally connected to said internal volume. Air containing moisture flows into and through the internal volume of the mixing chamber while the heat pipe transfers heat from the internal volume of the mixing chamber to a cold reservoir, causing said air humidity to condense into liquid water collected in the internal volume of the mixing chamber.

A method according to some aspects of the present invention includes collecting water that condenses on the surface of at least one heat pipe thermally connected to a cold reservoir. One of the heat pipe ends may be inside one or more mixing chambers where the water is collected. The air may be forced by a blower towards the surface of the heat pipe.

### CROSS-REFERENCE TO RELATED APPLICATIONS

This application claims the benefit of U.S. Provisional Patent Application No. 63/435,356, filed Dec. 27, 2022, which is incorporated herein by reference in its entirety.

### TECHNICAL FIELD

The present invention relates to producing water, more particularly, the invention relates production of water from the moisture in the air.

### BACKGROUND

Water is a basic human need. Millions of people are without access to clean water, many die from contaminated water sources. Half of the world's hospital beds are occupied by patients suffering from diseases associated with a lack of access to clean water. Millions spend hours each day collecting water from distant and polluted sources, walking miles for clean water. The time spent on the search for water can be time spent to generate income, for the family, and to get an education. Climate change will only make the situation worse. Many major cities are at risk of a water crisis, and water stress is projected to increase in most countries in the coming decades, threatening regional stability and raising the possibility of forced migrations. Water availability is not just harming humans it harms natural ecosystems with their habitats. According to the U.S. Intelligence Community Assessment of Global Water Security, by 2030 humanity's “annual global water requirements” will exceed “current sustainable water supplies” by 40%. Compared to today, five times as much land is likely to be under “extreme drought” by 2050. Water demand in India will reach 1.5 trillion cubic meters in 2030 while India's current water supply is only 740 billion cubic meters. Between 2050 and 2100, there is an 85 percent chance of a drought in the Central Plains and Southwestern United States lasting 35 years or more. According to a major report compiled in 2019 by more than 200 researchers, the Himalayan glaciers that are the sources of Asia's biggest rivers—Ganges, Indus, Brahmaputra, Yangtze, Mekong, Salween, and Yellow—could lose 66 percent of their ice by 2100. Approximately 2.4 billion people live in the drainage basin of the Himalayan rivers. India, China, Pakistan, Bangladesh, Nepal, and Myanmar could experience floods followed by droughts in the coming decades. In India alone, the Ganges provides water for drinking and farming to more than 500 million people. Scarcity varies over time as a result of natural hydrological variability, but varies even more so as a function of prevailing economic policy, planning, and management approach. Another cause of the water crisis is the increase in water consumption related to population growth, rising living standards, changing consumption patterns (e.g a shift toward an animal-based diet), and an increase in irrigation for farming. The International Resource Panel of the UN states that governments have tended to invest heavily in largely inefficient solutions: mega-projects like dams, canals, aqueducts, pipelines, and water reservoirs, which are generally neither environmentally sustainable nor economically viable.

The terms “production”, and “generation” may be used interchangeably hereinafter.

The terms “condensation chamber”, and “mixing chamber” may be used interchangeably hereinafter.

The terms “cold reservoir”, and “heat sink” may be used interchangeably hereinafter.

The terms “water production system”, and “production unit” may be used interchangeably hereinafter.

### SUMMARY OF EMBODIMENTS OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The present invention is intended to enable the production of water both on a large scale and on a domestic scale in a way that can contribute to tackling the increasingly acute water shortage.

A heat pipe is a heat-transfer device that employs phase transition to transfer heat between two solid interfaces. At the hot interface of a heat pipe, a volatile liquid in contact with a thermally conductive solid surface turns into a vapor by absorbing heat from that surface. The vapor then travels along the heat pipe to the cold interface and condenses back into a liquid, releasing the latent heat. The liquid then returns to the hot interface through either capillary action, centrifugal force, or gravity, and the cycle repeats. Due to the very high heat transfer coefficients for boiling and condensation, heat pipes are highly effective thermal conductors.

A water generation system according to some aspects of the present invention includes at least one condensation chamber having at least one internal volume, and at least one heat pipe thermally connected to said internal volume. Air containing moisture flows into and through the internal volume of the mixing chamber while the heat pipe transfers heat from the internal volume of the mixing chamber to a cold reservoir, causing said air humidity to condense into liquid water collected in the internal volume of the mixing chamber. A blower may be used to drive the air into and through the mixing chamber. The cold reservoir can be fresh water, salt water, effluent, soil, gas, cool air, and combinations thereof. The saltwater can be seawater or brine. The heat pipe can on one of its ends be used to warm water in a swimming pool while producing water on its other end by condensation. As mentioned, soil can also serve as a cold reservoir, especially when the soil is cold, especially in its depths. A source of cool air can be from high layers of the atmosphere such as by placing the end of the heat pipe at a high altitude, connecting it to the top of tall buildings, or to air-hovering objects such as balloons. Another possibility is a downward flow of air from high air layers, for example with an air pipe whose end is located at a high altitude or is connected to the top of tall buildings or to flying objects. The end of the heat pipe that is in contact with the cold reservoir may have a structure with a high ratio of heat transfer area to volume, similar to the structure of a heat exchanger or cooling fins to increase the heat removal rate to the cold reservoir. In some embodiments, the water generation system is installed on a vehicle including cars, trucks, trains, vessels, aircraft, and spacecraft. The advantages of installing such a system in vehicles include the possibility of utilizing the movement of the vehicle to increase the rate of heat removal from the heat pipe and the possibility of utilizing the condensed water for the needs of the vehicle and its users. It should be clear that the cold reservoir in such a case depends on the type of vehicle, whether it is air in the case of land vehicles or aircraft, water in the case of vessels, or space in the case of spacecraft. In some embodiments, the heat pipe is thermally connected to a coolant pipe exiting an evaporator and entering a condenser of a refrigeration system. This coolant pipe serves as the cold reservoir. Refrigeration systems can be of various sizes and types, e.g large-scale air conditioning, domestic air conditioning, refrigerators, and vehicle air conditioning. In some examples, at least one coolant pipe exiting an evaporator of a refrigeration system passes through the mixing chamber, serving as another element on which air humidity can condense.

A method according to some aspects of the present invention includes collecting water that condenses on the surface of at least one heat pipe thermally connected to a cold reservoir. One of the heat pipe ends may be inside one or more mixing chambers where the water is collected. The air may be forced by a blower towards the surface of the heat pipe.

### BRIEF DESCRIPTION OF THE DRAWINGS

A complete understanding of the present embodiments and the advantages and features thereof will be more readily understood by reference to the following detailed description when considered in conjunction with the accompanying drawings. Embodiments of the present disclosure are illustrated as examples and are not limited by the figures of the accompanying drawings, in which like references may indicate similar elements and in which:

FIG. 1A illustrates schematically a side view of a water generation system according to some embodiments of the present invention.

FIG. 1B illustrates schematically a view from the direction of the air inlet of a water generation system according to some embodiments of the present invention.

FIG. 2 illustrates schematically a water generation system according to some embodiments of the present invention where the heat pipe is thermally connected to coolant pipe.

FIG. 3 illustrates schematically a water generation system according to some embodiments of the present invention where the mixing chamber is connected to a part of an aircraft.

FIG. 4 illustrates schematically a water generation system according to some embodiments of the present invention that includes a rainwater collection basin.

FIG. 5 illustrates schematically a water generation system according to some embodiments of the present invention with a number of heat pipes.

FIG. 6 illustrates schematically a water generation system according to some embodiments of the present invention where a cooling fin structure is connected to the heat pipe.

FIG. 7 illustrates schematically a water generation system according to some embodiments of the present invention with a number of heat pipes connected to the mixing chamber wall.

FIG. 8 illustrates schematically a water generation system according to some embodiments of the present invention where the inner wall of the mixing chamber includes elements that contribute to increasing the area for heat transfer.

FIG. 9A illustrates schematically a water generation system according to some embodiments of the present invention with large area mixing baffles connected to the heat pipes.

FIG. 9B depicts schematically the longitudinal section of a mixing chamber according to some embodiments of the present invention.

FIG. 10 depicts schematically a cross-section of a mixing chamber according to some embodiments of the invention

FIG. 11 illustrates schematically a water generation system according to some embodiments of the present invention with a mixing chamber containing droplet separator.

FIG. 12 illustrates schematically a water generation system according to some embodiments of the present invention with moving blades for mixing the airflow.

FIG. 13 depicts schematically a water production site according to some embodiments of the invention.

FIG. 14A is a graph of experiments results comparing of water production rate at 30% Relative Humidity between a system embodying the present invention and a prior art system (benchmark).

FIG. 14B is a graph of experiments results comparing of water production rate at 40% Relative Humidity between a system embodying the present invention and a prior art system (benchmark).

FIG. 14C is a graph of experiments results comparing of water production rate at 50% Relative Humidity between a system embodying the present invention and a prior art system (benchmark).

FIG. 14D is a graph of experiments results comparing of water production rate at 60% Relative Humidity between a system embodying the present invention and a prior art system (benchmark).

FIG. 14E is a graph of experiments results comparing of water production rate at 70% Relative Humidity between a system embodying the present invention and a prior art system (benchmark).

FIG. 14F is a graph of experiments results comparing of water production rate at 80% Relative Humidity between a system embodying the present invention and a prior art system (benchmark).

FIG. 14G is a graph of experiments results comparing of water production rate at 90% Relative Humidity between a system embodying the present invention and a prior art system (benchmark).

### DETAILED DESCRIPTION OF EMBODIMENTS

The specific details of the single embodiment or variety of embodiments described herein are to the described system and methods of use. Any specific details of the embodiments are used for demonstration purposes only, and no unnecessary limitations or inferences are to be understood thereon. Before describing in detail exemplary embodiments, it is noted that the embodiments reside primarily in combinations of components and procedures related to the system. Accordingly, components have been represented, where appropriate in the drawings, showing only those details that are pertinent to understanding the embodiments of the present disclosure so as not to obscure the disclosure with details that will be readily apparent to those of ordinary skill in the art having the benefit of the description herein.

Water is a basic human need. Millions of people are without access to clean water, many die from contaminated water sources. Half of the world's hospital beds are occupied by patients suffering from diseases associated with a lack of access to clean water. Millions spend hours each day collecting water from distant and polluted sources, walking miles for clean water. The time spent on the search for water can be time spent to generate income, for the family, and to get an education. climate change will only make the situation worse. Many major cities are at risk of a water crisis, and water stress is projected to increase in most countries in the coming decades, threatening regional stability and raising the possibility of forced migrations. Water availability is not just harming humans it harms natural ecosystems with their habitats. According to the U.S. Intelligence Community Assessment of Global Water Security, by 2030 humanity's “annual global water requirements” will exceed “current sustainable water supplies” by 40%. Compared to today, five times as much land is likely to be under “extreme drought” by 2050.

The present invention is intended to enable the production of water both on a large scale and on a domestic scale in a way that can contribute to tackling the increasingly acute water shortage.

A heat pipe is a heat-transfer device that employs phase transition to transfer heat between two solid interfaces. At the hot interface of a heat pipe, a volatile liquid in contact with a thermally conductive solid surface turns into a vapor by absorbing heat from that surface. The vapor then travels along the heat pipe to the cold interface and condenses back into a liquid, releasing the latent heat. The liquid then returns to the hot interface through either capillary action, centrifugal force, or gravity, and the cycle repeats. Due to the very high heat transfer coefficients for boiling and condensation, heat pipes are highly effective thermal conductors. The effective thermal conductivity varies with heat pipe length and can approach 100 kW/(m·K) for long heat pipes, in comparison with approximately 0.4 KW/(m·K) for copper. A typical heat pipe consists of a sealed pipe or tube made of a material that is compatible with the working fluid such as copper for water heat pipes. The working fluid is selected so that the heat pipe contains both vapor and liquid over the operating temperature range. Heat pipes contain no mechanical moving parts and typically require minimum maintenance. Water generation according to aspects of the present invention utilizes a heat pipe refrigeration cycle, in some cases supplemented by a compressor refrigeration cycle.

The heat pipe transfers the heat of condensation to produce water. The heat pipe can also increase the cooling capacity of the compressor refrigeration cycle. The compression refrigeration cycle serves as a cold reservoir. The amount of water produced may be determined largely by four factors: the incoming air volume and its temperature; and the flow rate and temperature of the working fluid in the heat pipe. More water can be produced, the larger the air volume, the greater the flow rate of the working fluid in the heat pipe, and the lower the temperature of the working fluid in the heat pipe (however greater than the freezing point). Adjusting the relationship between these four factors may bring optimal working conditions, i.e maximal water production with minimal energy with the passive heat transfer characterizing the heat pipe utilized to minimize energy loss.

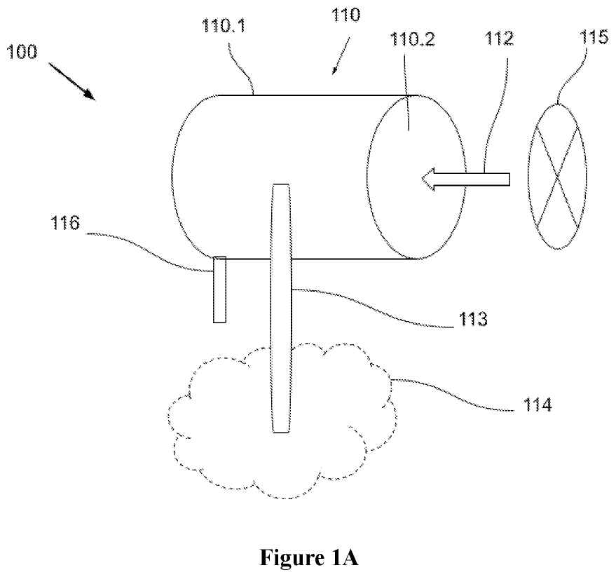

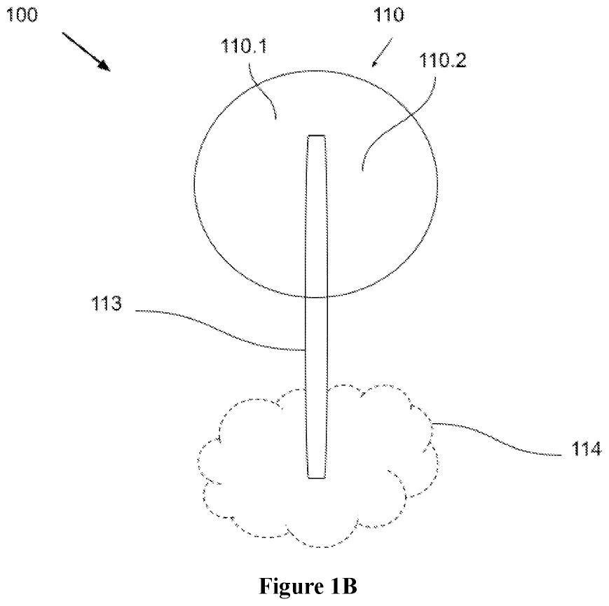

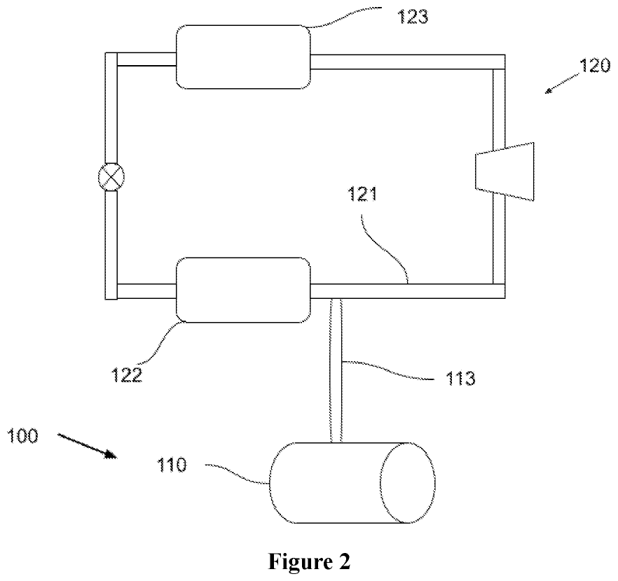

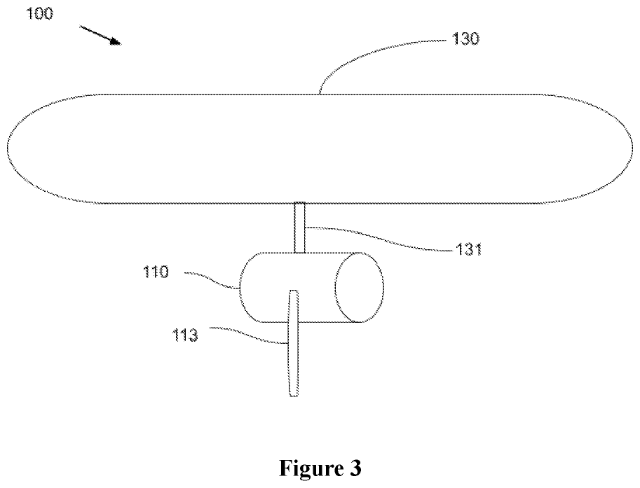

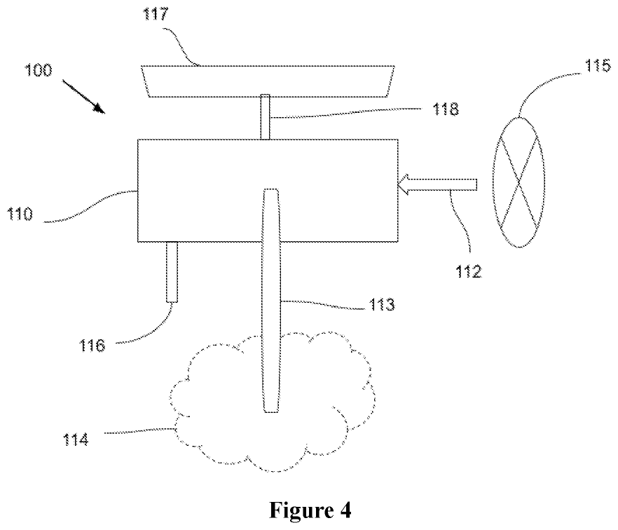

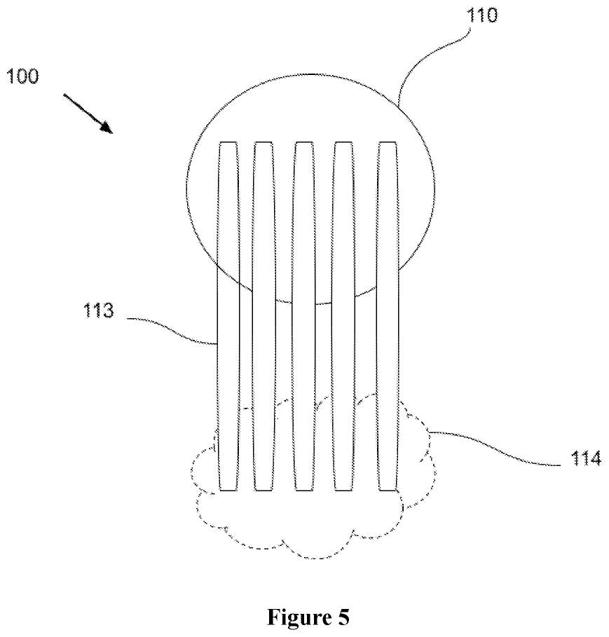

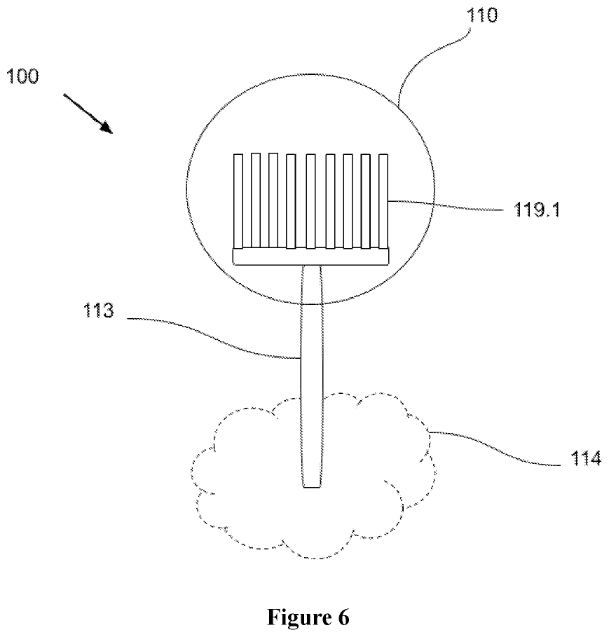

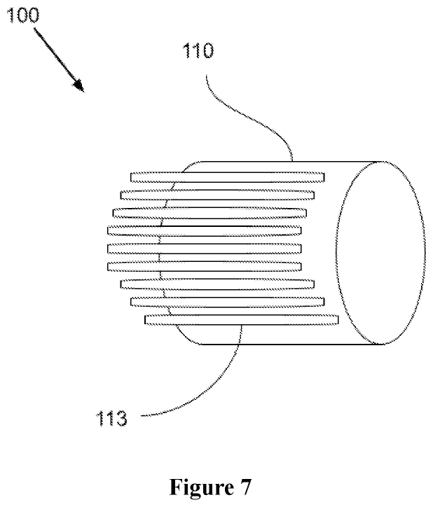

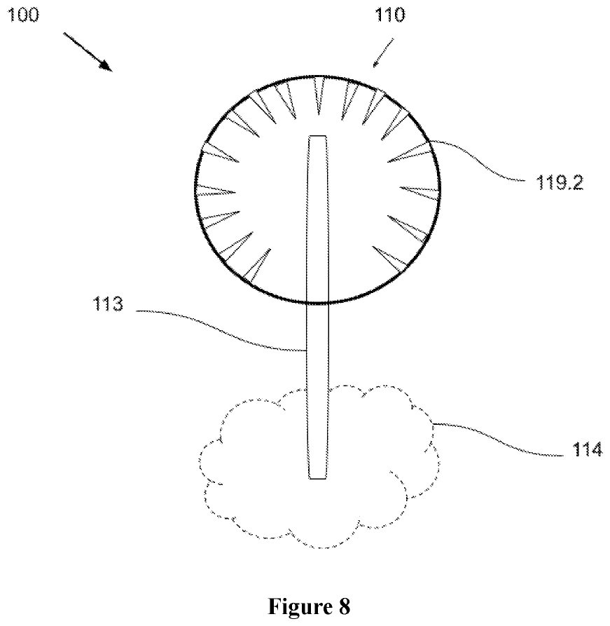

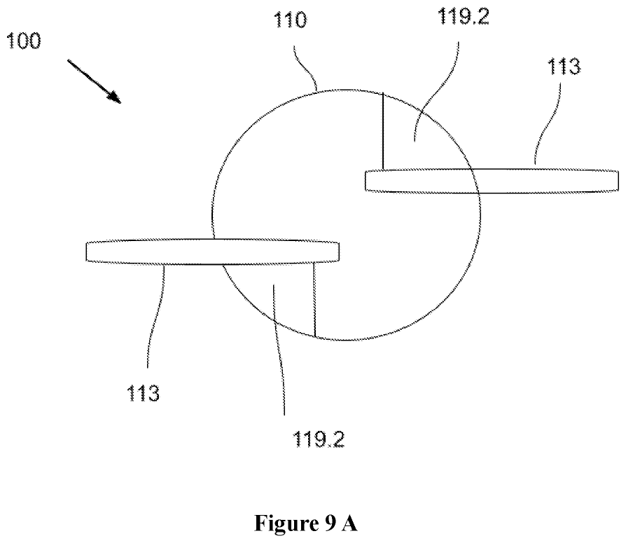

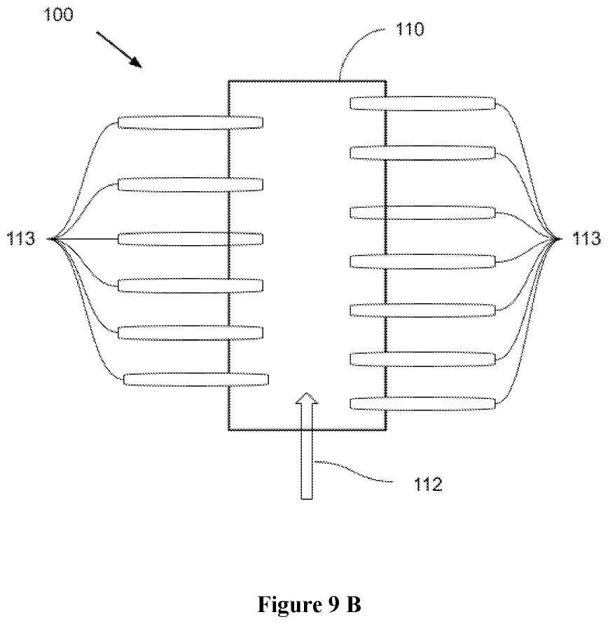

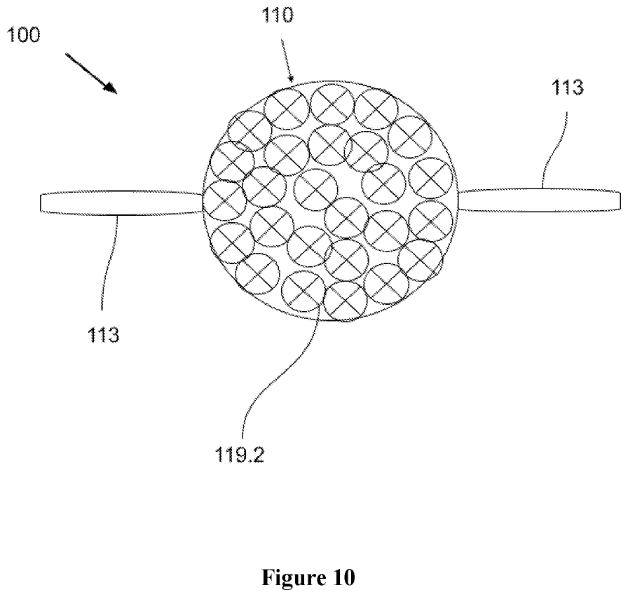

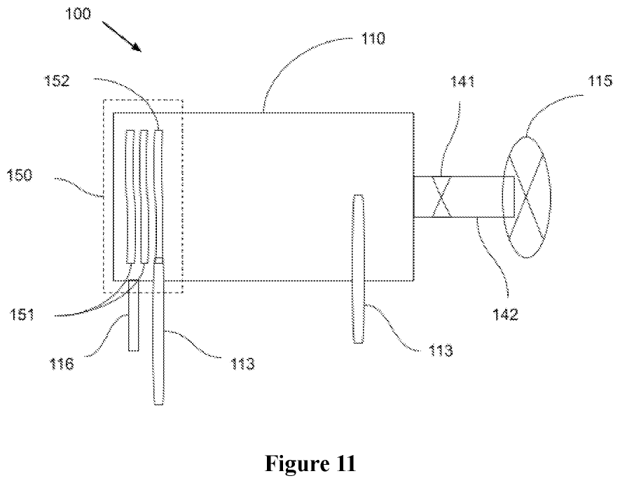

A water generation system according to some aspects of the present invention includes at least one condensation chamber having at least one internal volume, and at least one heat pipe thermally connected to said internal volume. Air containing moisture flows into and through the internal volume of the mixing chamber while the heat pipe transfers heat from the internal volume of the mixing chamber to a cold reservoir, causing the air humidity to condense into liquid water collected in the internal volume of the mixing chamber. Water generation system 100 according to some embodiments of the present invention illustrated schematically in FIG. 1A-B. System 100 includes mixing chamber 110 having wall 110.1 and internal volume 110.2 through which air 112 flows. Heat pipe 113 is used to remove heat from air 112 to cold reservoir 114. The cold reservoir can be fresh water, salt water, effluent, soil, gas, cool air, and combinations thereof. A side view of system 100 is illustrated schematically in FIG. 1A where blower 115 is illustrated, driving air 112 into internal volume 110.2. Tube 116 is used to drain water condensed from air 112 as a result of heat removal by heat pipe 113. A view from the direction of air 112 inlet to chamber 110 is schematically illustrated in FIG. 1B where is shown heat pipe 113 penetrating through wall 110.1 into internal volume 110.2. Blower 115 and tube 116 are not shown. In some cases, the cold reservoir can be a refrigeration system. In some embodiments depicted schematically in FIG. 2, heat pipe 113 is thermally connected to coolant pipe 121 exiting evaporator 122 and entering condenser 123 of refrigeration system 120. In some embodiments, the water generation system is installed on a vehicle including cars, trucks, trains, vessels, aircraft, and spacecraft. The advantages of installing such a system in vehicles include the possibility of utilizing the movement of the vehicle to increase the rate of heat removal from the heat pipe and the possibility of utilizing the condensed water for the needs of the vehicle and its users. The cold reservoir depends on the type of vehicle, whether it is air in the case of land vehicles or aircraft, water in the case of vessels, or space in the case of spacecraft. In FIG. 3, system 100 is schematically depicted where chamber 110 is connected to a part of an aircraft such as wing 130 through connection member 131. An option to increase the water production is schematically depicted in FIG. 4 where system 100 includes rainwater collection basin 117 fluidly connected by rainwater drainage tube 118 to the internal volume of mixing chamber 110. Another way to increase water production is by installing a number of heat pipes. System 100 having a number of heat pipes 113 to increase the removal of heat from the internal volume of the mixing chamber 110 is depicted in FIG. 5. Increasing heat removal is also possible as illustrated schematically in FIG. 6 where a cooling fin structure 119.1 is connected to heat pipe 113 inside the internal volume of mixing chamber 110. Cooling fins have a very large surface area to let heat out to the surroundings as quickly as possible. Fins are extended surfaces designed to increase heat transfer rates. The fins increase the effective area of a surface thereby increasing the heat transfer by convection. The fins can be with different profiles such as rectangular, triangular, trapezoidal, concave, cylindrical, and tapered. Different materials can be used for the fins, preferably materials with high conductivity. Aluminum alloy has one of the higher thermal conductivity values at 229 W/mK but is mechanically soft. Copper has around twice the thermal conductivity of aluminum and faster, more efficient heat absorption. But it is more expensive than aluminum. In many cases, the thermal connection of the heat pipe to the internal volume of the mixing chamber is, inter alia, through the wall of the mixing chamber e.g due to the contact between the heat pipe and the wall. Hence, the mixing chamber wall is utilized to transfer heat from the air flowing inside the internal volume of the mixing chamber to the cold reservoir. Thus, a considerable increase in the ratio between the volume of air and the area for heat transfer can lead to greater production of water. According to some embodiments of the invention, FIG. 7 schematically depicts a possible increase of the heat transfer from the air flowing in the internal volume of the mixing chamber 110, by connecting a plurality of heat pipes 113 to the mixing chamber wall. The heat pipes may be connected both to the outer wall of the mixing chamber and to the inner wall. In some embodiments of the invention, the inner wall of the mixing chamber includes elements that contribute to increasing the area for heat transfer, such as grooved surfaces, protrusions, depressions, and cooling fins 119.2 as schematically depicted in FIG. 8. Such elements can be used to increase the mixing of the air inside mixing chamber 110. Mixing can be helpful in improving the removal of heat from the air by reducing the laminar flow of the air near the walls caused by friction. The energy for such kind of mixing sometimes referred to as “static mixing”, comes from a loss in pressure when the air flows through the static mixing elements. As the air stream moves through the mixer, the non-moving elements continuously cause air mixing. One design of a static mixer is the plate-type mixer. Elements 119.2, according to some embodiments of the invention, serving as both cooling fins and mixing baffles, are schematically depicted in FIGS. 9A-B. The cross-section of mixing chamber 110 is depicted in FIG. 9A where elements 119.2 are large area mixing baffles connected to heat pipes 113 thus serving as cooling fins simultaneously. The longitudinal section of mixing chamber 110 is shown in FIG. 9B where heat pipes 113 to which elements 119.2 (not shown) are connected are located longitudinally in the direction of airflow 112. Heat pipes 113 protrude alternately from opposite directions into the internal volume of chamber 110. In some embodiments mixing elements are contained in a cylindrical (tube) or squared housing. In the housed-elements design, the static mixer elements consist of a series of baffles. Mixing elements can be helical that simultaneously produce patterns of flow division and radial mixing. In laminar flow, the air divides at the leading edge of each element and follows the channels created by the element shape. At each succeeding element, the two channels are further divided, resulting in an exponential increase in stratification. Radial mixing in either turbulent flow or laminar flow is caused by the rotational circulation of the air around its own hydraulic center in each channel of the static mixer. In this way, radial gradients in temperature may be eliminated. A schematic depiction of a cross-section of mixing chamber 110 according to some embodiments of the invention is shown in FIG. 10 where heat pipes 113 are connected to the mixing chamber 110 walls whose internal volume is filled with helical mixing elements 119.2 which can be made of conductive material to significantly increase the heat transfer area hence increasing water production. Mixing chamber 110 exemplifying some embodiments of the invention is depicted schematically in FIG. 11 where blower 115 is used to push airflow into the internal volume of the mixing chamber 110. The operation of blower 115 can be controlled to optimize the airflow for maximum water production and for saving energy. Valve 141 installed in air duct 142 between blower 115 to mixing chamber 110, can also be used to control the airflow into mixing chamber 110. Different types of drop separators are included in some embodiments of the present invention. In the embodiment depicted in FIG. 11, section 150 of mixing chamber 110 contains a droplet separator with baffle vanes 151 designed for capturing and separating drops from the airflow. In some embodiments a type of baffle vanes 152 is connected to heat pipes 113, thus serving as cooling fins at the same time. In vane-type separators 150, offered for example by “Lechler”, droplets flow through a band of curved vanes. Forces of inertia act upon the droplets while these are subject to directional flow changes in the baffle vanes. These forces divert the droplets from the airflow. Droplets come in contact with the baffle-vane and then join with others to form a film of liquid. The curvature and shape of the baffle vanes are such that the film of liquid formed on their surfaces is removed from the airflow. This is generally achieved by the baffle vanes having specially-formed phase-separation spaces. Where droplet separators are concerned that have to work with as little pressure loss as possible the baffle vanes are provided with a series of grooves that act as phase separators.

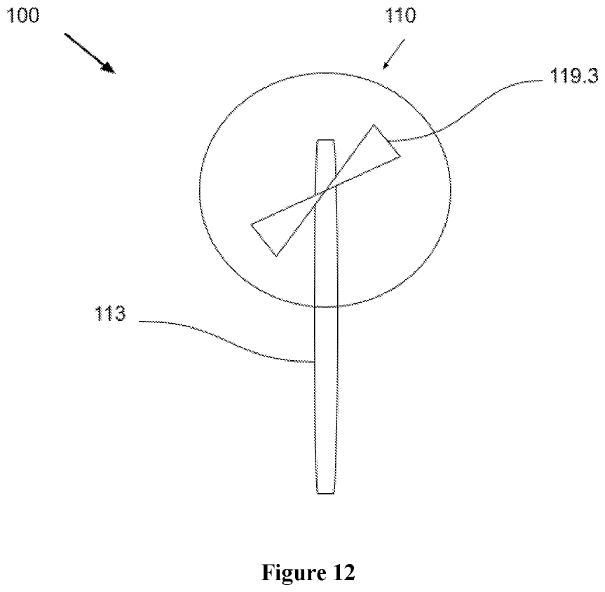

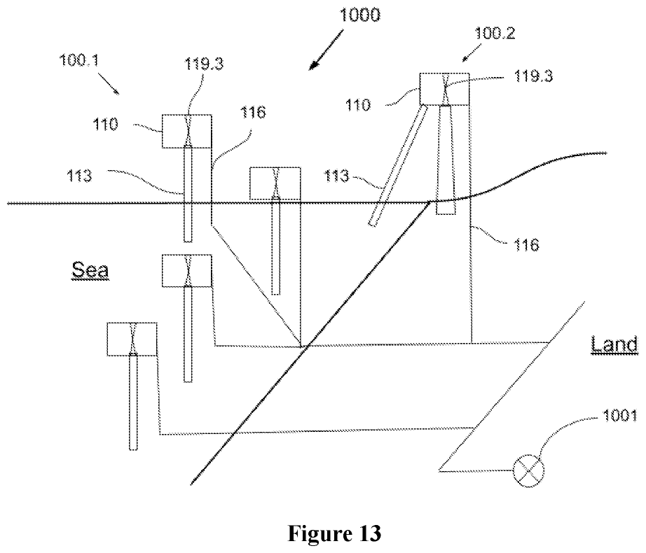

Increasing the mixing of airflow can also be achieved with moving elements such as moving blades (e.g. turbine, propeller) 119.3 schematically depicted in FIG. 12. The blades can rotate by the force exerted by the movement of the air pushing them (passive propulsion), or be driven independently by a motor. In the case where the blades rotate by the force of the airflow, their rotation can be utilized to produce electricity. Several water production systems 100 can be integrated. Such integration as production site 1000 is depicted schematically in FIG. 13. Site 1000 is located on the seashore and includes marine production units 100.1 located in the sea, and land production unit 100.2 located on the beach. Each production unit includes one or more turbines 119.3 for generating electricity and mixing the air in condensing chambers 110. The electricity produced by the production units at site 1000 can be supplied to the grid or directly to a consumer e.g. plant, resort, drilling rig, or community. For the production of water in the production units, the cold reservoir to which the heat is removed through heat pipes 113 is seawater. The water produced in the production units flows through piping 116 to the main pumping unit 1001, and from there to the consumers.

### EXAMPLES

Reference is now made to the following examples, which together with the above descriptions illustrate some embodiments of the invention in a non-limiting fashion.

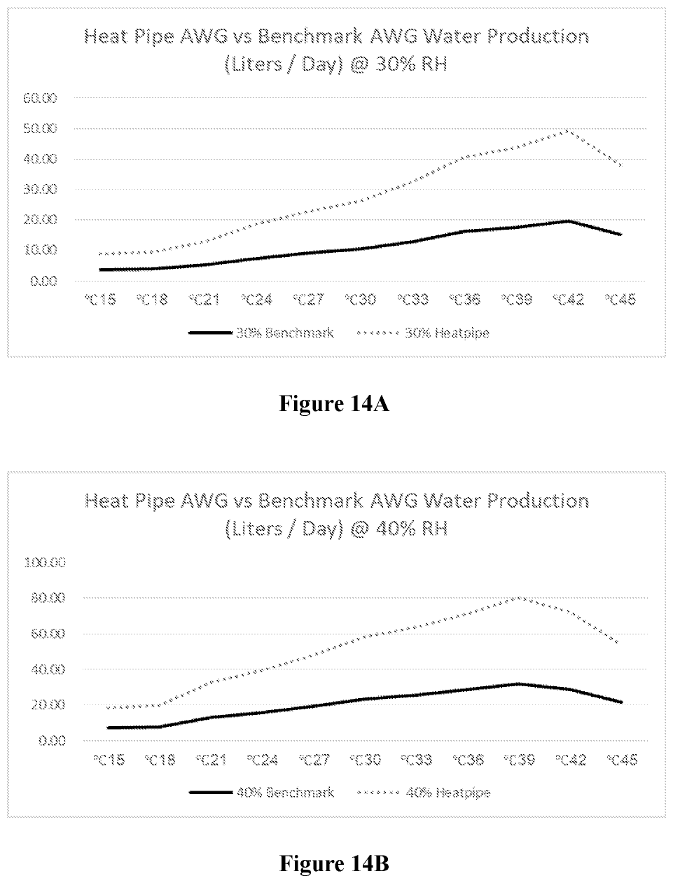

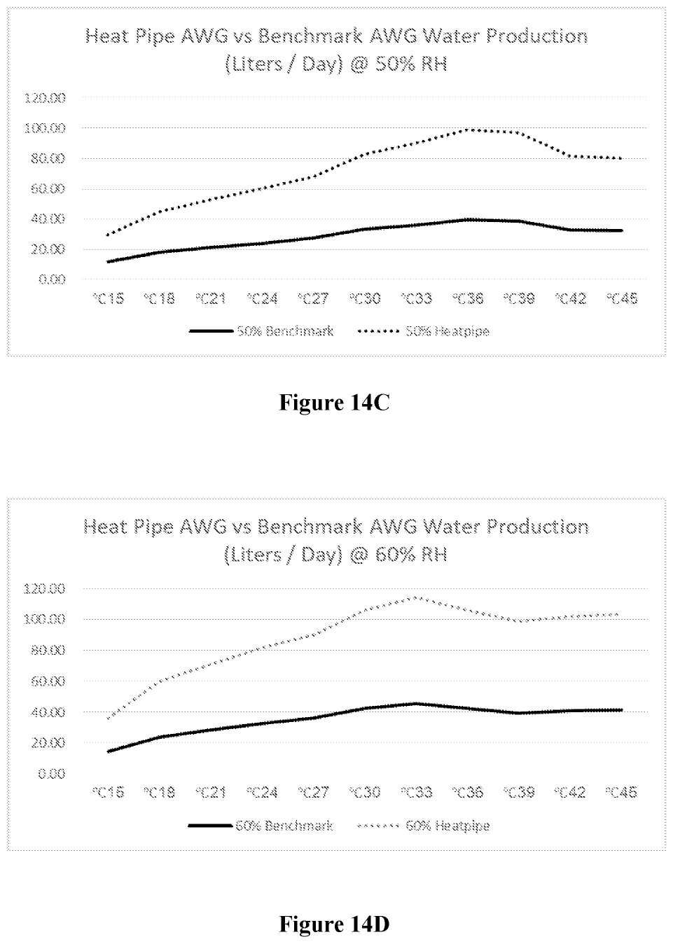

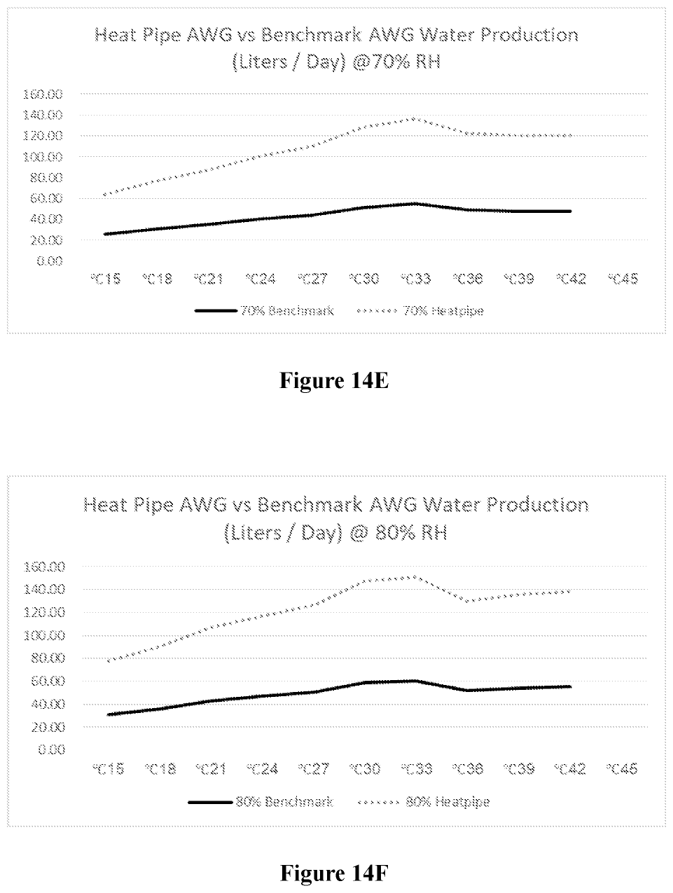

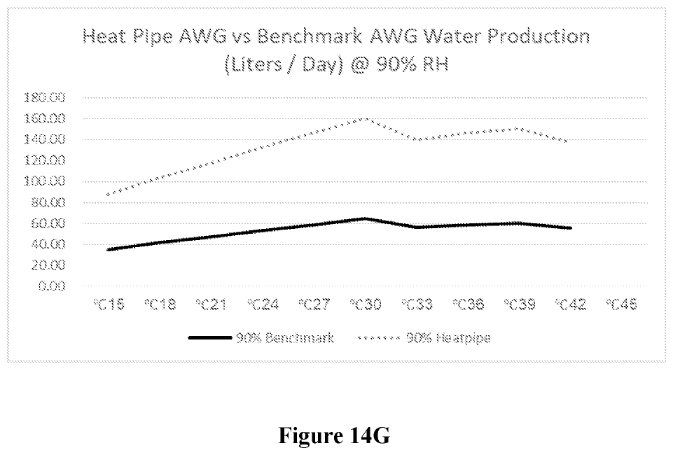

The graphs in FIGS. 14A-G present experiments results comparing of water production rate between a system embodying the present invention and a prior art system (benchmark). During the experiments, airspeed was kept at 410 m3/h. The results shown in the graphs are at different temperatures (X-axis), at a different relative humidity in each graph from 30% to 90% at incrementations of 10%. The Y axis represents the water output in liters per day. The solid lines represent the results of the prior art system, and the dotted lines represent the results of a system embodying the present invention. As can be seen in the graphs, the system embodying the present invention produces a significantly greater amount of water. Especially around a temperature range of 30-40° C. The higher the relative humidity, the peak in the difference in water yield is obtained at a lower temperature, around 30° C.

It should be understood that elements and/or features of an apparatus, or a method described herein can be combined in a variety of ways without departing from the spirit and scope of the present teachings, whether explicit or implicit herein. For example, where reference is made to a particular structure, that structure can be used in various embodiments of apparatus of the present teachings and/or in methods of the present teachings, unless otherwise understood from the context. In other words, within this application, embodiments have been described and depicted in a way that enables a clear and concise application to be written and drawn, but it is intended and will be appreciated that embodiments may be variously combined or separated without parting from the present teachings and invention(s). For example, it will be appreciated that all features described and depicted herein can be applicable to all aspects of the invention(s) described and depicted herein.

It should be understood that the expression “at least one of” includes individually each of the recited objects after the expression and the various combinations of two or more of the recited objects unless otherwise understood from the context and use.

The use of the term “include,” “includes,” “including,” “have,” “has,” “having,” “contain,” “contains,” or “containing,” including grammatical equivalents thereof, should be understood generally as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

The use of any and all examples, or exemplary language herein, for example, “such as,” “including,” or “for example,” is intended merely to better illustrate the present teachings and does not pose a limitation on the scope of the invention unless claimed. No language in the specification should be construed as indicating any non-claimed element as essential to the practice of the present teachings.

The present teachings encompass embodiments in other specific forms without departing from the spirit or essential characteristics thereof. The foregoing embodiments are therefore to be considered in all respects illustrative rather than limiting on the present teachings described herein.

1. A water generation system comprising:
at least one condensation chamber having at least one internal volume; and
at least one heat pipe thermally connected to said internal volume,
wherein air containing moisture flows into and through said internal volume of said chamber, wherein said heat pipe adapted to transfer heat from said internal volume of said chamber to a cold reservoir, causing said air humidity to condense into liquid water collected in said internal volume of said chamber.

2. The water generation system of claim 1, wherein said cold reservoir is selected from the group consisting of fresh water, salt water, effluent, soil, gas, air, and combinations thereof.

4. The water generation system of claim 1, wherein said system installed on vehicles selected from the group consisting of a car, a truck, a train, a vessel, aircraft, and a spacecraft.

5. The water generation system of claim 1, wherein said heat pipe is thermally connected to a coolant pipe exiting an evaporator and entering a condenser of a refrigeration system.

6. The water generation system of claim 1, wherein at least one coolant pipe exiting an evaporator of a refrigeration system passes through said condensation chamber

7. The water generation system of claim 1, wherein said air is driven by a blower.

8. The water generation system of claim 1 comprising a plurality of said heat pipes attached to said condensation chamber wall.

9. The water generation system of claim 1 comprising at least one air mixing element installed inside said condensation chamber.

10. A method for producing water comprising collecting water that condenses on the surface of at least one heat pipe wherein said heat pipe is thermally connected to a cold reservoir.

11. The method of claim 10, wherein said collecting is in at least one condensation chamber.

12. The method of claim 10, comprising blowing humid air over said surface of said heat pipe.

13. The method of claim 10, wherein said system is installed on a vehicle selected from the group consisting of a car, a truck, a train, a vessel, aircraft, and a spacecraft.

14. The method of claim 10, wherein said heat pipe thermally connected to a coolant pipe, said coolant pipe exiting an evaporator and enters a condenser of a refrigeration system.

15. The method of claim 10, wherein at least one coolant pipe exiting an evaporator of a refrigeration system passes through said condensation chamber.
